(19) United States
(12) Patent Application Publication
(10) Pub. No.: US 2014/0304069 A1
(43) Pub. Date: Oct. 9, 2014

(54) BUDGET ALLOCATION FOR CONTENT DISTRIBUTION

(71) Applicant: Google Inc., Mountain View, CA (US)

(72) Inventors: Vincent P. Lacey, Mountain View, CA (US); Keith Howard, Mountain View, CA (US); Ido Ohad, Mountain View, CA (US); David Norelius, Mountain View, CA (US); Michael F. English, Mountain View, CA (US); John P. Simons, Mountain View, CA (US); Douglas R. Bengtson, Mountain View, CA (US); Jesse Kinkead, Mountain View (US); Ekaterina A. Mineeva, Mountain View, CA (US); Will Stoltzman, Mountain View, CA (US); Lee Callender, Mountain View, CA (US)

(21) Appl. No.: 13/930,746

(22) Filed: Jun. 28, 2013

(30) Foreign Application Priority Data
Apr. 4, 2013 (IL) 225560

(51) Int. Cl. G06Q 30/02

(52) U.S. Cl. CPC G06Q 30/0249
USPC 705/14.48

(57) ABSTRACT

An example budget allocation process may include: determining how to allocate a budget among different content distribution mechanisms, and generating a graphical user interface showing allocations of the budget among the different content distribution mechanisms, where the graphical user interface includes elements to vary the allocations, and where the elements are movable to trigger variations in the allocations. The example process may also include: receiving an input from the graphical user interface; determining a reallocation of the budget among the different content distribution mechanisms based on the input; and updating the graphical user interface using the reallocation of the budget among the different content distribution mechanisms. The graphical user interface may be updated so that at least some of the elements and information relating to the content distribution mechanisms reflect the reallocation of the budget.

### CROSS-REFERENCE TO RELATED APPLICATION

Priority is hereby claimed to Israeli Patent Application No. 225560, which was filed on Apr. 4, 2013 and entitled “BUDGET ALLOCATION FOR CONTENT DISTRIBUTION”. The contents of Israeli Patent Application No. 225560 are hereby incorporated by reference into this disclosure.

### TECHNICAL FIELD

This disclosure relates generally to budget allocation for content distribution.

### BACKGROUND

The Internet provides access to a wide variety of resources. For example, video, audio, and Web pages are accessible over the Internet. These resources present opportunities for other content (e.g., advertisements, or “ads”) to be provided along with the resources. For example, a Web page can include slots in which ads can be presented. The slots can be allocated to content providers (e.g., advertisers). An auction can be performed for the right to present advertising in a slot. In the auction, content providers submit bids specifying amounts that the content providers are willing to pay for presentation of their content.

Content providers, such as advertisers, may distribute content through an auction, or outside of the context of an auction, based on various types of information. Examples of such information include, but are not limited to, keywords, geography, and demographics. Content providers, however, have limited resources (e.g., money). Content providers attempt to allocate those resources to methods of content distribution that provide an overall benefit, such as an increased number of conversions.

### SUMMARY

An example budget allocation process may include: determining, using one or more processing devices, how to allocate a budget among different content distribution mechanisms, where a content distribution mechanism includes a method of distributing content over one or more communications media; and generating a graphical user interface showing allocations of the budget among the different content distribution mechanisms, where the graphical user interface includes elements to vary the allocations, and where the elements are movable to trigger variations in the allocations. The example process may also include: receiving an input from the graphical user interface, where the input indicates that at least one of the elements has been moved; determining, using the one or more processing devices, a reallocation of the budget among the different content distribution mechanisms based on the input received from the graphical user interface; and updating the graphical user interface using the reallocation of the budget among the different content distribution mechanisms. The graphical user interface may be updated so that at least some of the elements and information relating to the content distribution mechanisms reflect the reallocation of the budget. The example process may include one or more of the following example features, either alone or in combination.

The example process may include locking one or more budget allocations to corresponding content distribution mechanisms. The reallocation may be determined without affecting the one or more budget allocations to the corresponding content distribution mechanisms.

The elements may include sliders and the information relating to the content distribution mechanisms may include content distribution statistics for a content distribution mechanism that correspond to a budget allocation for the content distribution mechanism. Updating the graphical user interface may include changing display of at least some of the elements and at least some of the content distribution statistics. Changes to display of at least some of the elements and at least some of the content distribution statistics may be performed in real-time.

At least one of the content distribution mechanisms may include one or more options for distributing content that falls within a category of the at least one content distribution mechanism. The example process may include locking an allocation for at least one of the options. The allocation for at least one of the options may be unaffected by the reallocation. Reallocation may affect at least one other option within the at least one content distribution mechanism but allocations for other content distribution mechanisms are unaffected by the reallocation. Reallocation may affect a content distribution mechanism other than the at least one content distribution mechanism

Determining how to allocate or to reallocate the budget may include, for multiple content distribution campaigns: identifying distribution clusters associated with a campaign for content distribution, where a distribution cluster includes a type of information used to distribute content and one or more instances of the type of information; and determining relative conversion rates for the distribution clusters, where a relative conversion rate indicates a performance of a distribution cluster relative to a baseline performance for the campaign, and at least some of the distribution clusters use different types of information to distribute content. Relative conversion rates for similar distribution clusters may be used in different campaigns in determining how to allocate or to reallocate the budget among the different content distribution mechanisms.

The example processes may include entering a cap into the graphical user interface for restraining reallocation of advertising budget.

Two or more of the features described in this disclosure/specification, including this summary section, can be combined to form implementations not specifically described herein.

The systems and techniques described herein, or portions thereof, can be implemented as a computer program product that includes instructions that are stored on one or more non-transitory machine-readable storage media, and that are executable on one or more processing devices. The systems and techniques described herein, or portions thereof, can be implemented as an apparatus, method, or electronic system that can include one or more processing devices and memory to store executable instructions to implement the stated operations.

The details of one or more implementations are set forth in the accompanying drawings and the description below. Other features and advantages will be apparent from the description and drawings, and from the claims.

### DESCRIPTION OF THE DRAWINGS

FIG. 1 is an example of a graphical user interface showing a mechanism for allocating budget for content distribution.

FIG. 2 is a block diagram of an example network environment on which the example processes described herein can be implemented.

FIG. 3 is an example a process for determining budget allocation for content distribution.

FIG. 4 is another example of a graphical user interface showing a mechanism for allocating budget for content distribution.

FIG. 5 is an example of a graphical user interface showing information upon which budget allocation for content distribution is based.

FIG. 6 is an example a process for determining budget allocation for content distribution that uses relative conversion rates.

FIG. 7 is an example of a computer system on which the processes described herein may be implemented.

Like reference symbols in the various drawings indicate like elements.

### DETAILED DESCRIPTION

Content, such as advertising, may be provided to network users based, e.g., on demographics, keywords, language, and interests. For example, advertising (an “ad”) may be associated with one or more keywords that are stored as metadata along with the ad. A search engine, which operates on the network, may receive input from a user. The input may include one or more of the keywords. A content management system, which serves ads, may receive the keywords from the search engine, identify the ad as being associated with one or more of the keywords, and output the ad to the user, along with content that satisfies the initial search request. The content and the ad are displayed on a computing device. When displayed, the ad is incorporated into an appropriate slot on the results page. The user may select the ad by clicking-on the ad. In response, a hyperlink associated with the ad directs the user to another Web page. For example, if the ad is for ABC Travel Company, the Web page to which the user is directed may be the home page for ABC Travel Company. This activity is known as click-through. In this context, a “click” is not limited to a mouse click, but rather may include a touch, a programmatic selection, or any other interaction by which the ad may be selected.

A content auction may be run to determine which content is to be output in response to an input, such as one or more keywords. In the auction, content providers may bid on specific keywords (which are associated with their content). For example, a sporting goods ads provider may associate words such as “baseball”, “football” and “basketball” with their ads. The content provider may bid on those keywords in the content auction, typically on a cost-per-click (CPC) basis. The content provider's bid is an amount (e.g., a maximum amount) that the provider will pay in response to users clicking on their displayed content. So, for example, if a content provider bids five cents per click, then the content provider may pay five cents each time their content is clicked-on by a user, depending upon the type of the auction. In other examples, payment need not be on a CPC basis, but rather may be on the basis of other actions (e.g., an amount of time spent on a landing page, a purchase, and so forth).

Bidding in a content auction typically takes place against other content providers bidding for the same keywords. So, for example, if a user enters keywords into a search engine (to perform a search for related content), a content management system may select content items from different content providers, which are associated with those same keywords or variants thereof. The content auction is then run (e.g., by the content management system) to determine which content to serve along with the search results (or any other requested content). Typically, the winner of the content auction obtains the most preferred slots on a results page. The winner may be decided, e.g., based on bidding price, relevance of the keywords to content, and other factors. In this context, a page includes any display area, such as a Web page, a continuously scrollable screen, and so forth. In some examples, winners of the auction will be accorded the most preferred slot(s) on the page, while others will be accorded slots that are less preferred.

Using explicitly entered search keywords in auctions is an example of one of many approaches to implementing a content auction. For example, in some types of content network auctions, keywords are extracted from one or more pages surrounding content and used to identify, and implement, a content auction.

In some cases, rather than bidding on keywords, content providers may bid on other types of information. For example, a content provider may bid to distribute content to a particular geographic area, to a particular demographic, to particular types of content (e.g., Web pages), combinations of these, and so forth.

In some implementations, content providers may distribute content outside of an auction context, and use any of the types of information described herein (and others) to distribute content. For example, content providers may directly purchase space on Web pages that contain content about a particular subject or that are known to be frequented by a particular demographic. In other examples, content providers may pay to distribute their content to a particular geographic area. For example, the content may be distributed only to users known to live in, or frequent, a specific city, state, country, and so forth. Reservation-based content (e.g., advertising) sales involve providing a guaranteed number of impressions/clicks for a time range or exclusivity for one or more days. For example, content providers, such as advertisers or ad agencies, may reserve slots on Web pages, video services, or other publisher's media.

In some implementations, content may be distributed through (e.g., along with) video. Content may be distributed in this manner through an auction, reservation or other mechanisms. The content provider's budget allocation may be distributed across search, display, video, and reservation mechanisms.

Content provider budgets are limited. Accordingly, it benefits content providers to have a way to allocate that budget in order to achieve an increase on their investment. In some implementations, a graphical user interface (GUI) may be generated to provide users with a way to view budget allocations among different advertising distribution methods, and to change an allocation and view, in real time, how that change in allocation affects other budget allocations. Budget allocations may be made by comparing a current content (e.g., ad) distribution campaign to past campaigns having one or more features in common with the current campaign, and about which statistics have been stored (with appropriate permission).

The following examples are described in the context of online advertising (“ads”); however, the systems described herein are applicable to determining resource allocation and display for any appropriate content.

In example implementations, the GUI is generated by a system that receives a budget, identifies advertising products (e.g., content distribution methods) that may be used to consume all or part of the budget, and allocates the advertising budget to the various products. The advertising products and corresponding budget allocations may be determined based on prior performance of advertising products and allocations for similar advertising campaigns under similar circumstances. The GUI may be generated to allow users to view the budget allocations and to adjust the budget allocations to show the impact of changes to a budget allocation for one advertising product on budget allocations for other advertising products. In some implementations, the GUI allows the user to lock one or more parameters, thereby preventing reallocations from affecting the locked parameters.

The GUI may also include columns indicating effects of various budget allocations on performance, such as an expected number of impressions, costs associated with actions (e.g., clicks) for that number of impressions, and expected number of conversions. In some implementations, the GUI may also include features for allowing the user to view information about the prior performance of advertising products for like advertisers. In this regard, a GUI, such as that described herein, is typically used by an advertising broker, whose employees will normally have prior permission to access and to view such information. However, in cases where there is not prior permission to access and to view such information, such permission may need to be obtained beforehand before permitting a user to view information about the prior performance of advertising products for other advertisers.

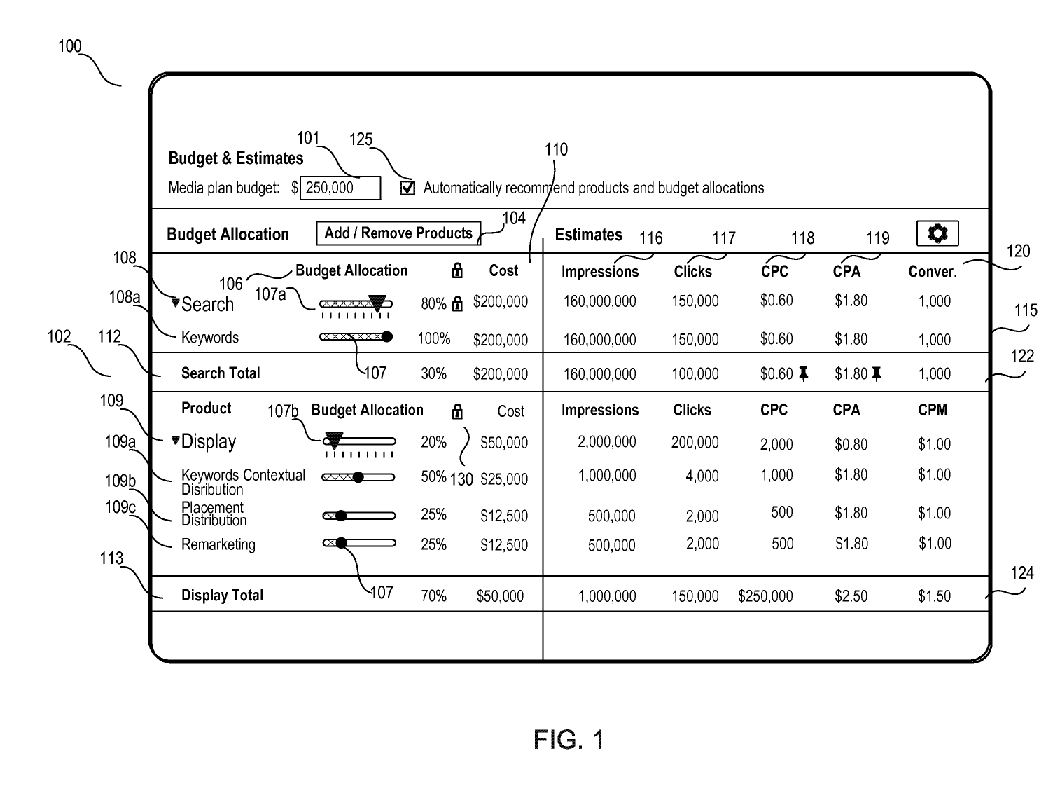

FIG. 1 shows an example implementation of a GUI 100 such as that described above. GUI. 100 is described in the context of online advertising (“ads”); however, other implementations of GUI 100 may be used to display resource allocation for any appropriate online content or other distributable content.

GUI 100 includes a field 101 identifying an advertising budget (e.g., $250,000) to be allocated to various ad products 102. An ad product, in this example, includes a method of distributing advertising. For example, the “Search” ad product distributes advertising in response to a request input through a search engine (e.g., through an auction). The “Display” ad product distributes advertising on Web sites, and not usually in response to search inputs (e.g., based on information such as geography, demographics, and so forth). Other ad products (not shown) may also be listed. For example, the “Ad/Remove Ad Products” button 104 may be used to add additional ad products to GUI 100 or to remove existing ad products from GUI 100. Addition or removal of ad products may also be automatic.

Budget allocation column 106 includes sliders 107 to show how the budget from field 101 is to be allocated among ad products 102. In the example of FIG. 1, 80% of the $250,000 budget is allocated to Search ad product 108 and 20% of the $250,000 budget is allocated to the Display ad product 109. Each ad product also includes one or more options for distribution. For example, Search ad product 108 provides an option to distribute content based on keywords 108a. In this example, a keyword input to a search engine may match a keyword associated with an ad and, in response to that match, the ad may be served. In another example, Display ad product 109 may provide options to distribute content using keyword distribution 109a, placement distribution 109b, and remarketing distribution 109c. For keyword distribution, keywords in a publication (e.g., a Web site) may be matched to keywords associated with an ad for the ad to be displayed in the content. For placement targeting, ads may be displayed at particular locations on publications (e.g., Web sites). For remarketing, with appropriate permission from each user, the system may identify users who have visited particular sites and distribute ads to those users.

In the example of FIG. 1, 100% of the 80% allocated to the Search ad product 108 is used for keywords 108a distribution. In the example of FIG. 1, 50% of the 20% allocated to the Display ad product 109 is used for keywords 109a distribution, 25% of the 20% allocated to the Display ad product 109 is used for placement 109b distribution, and 25% of the 20% allocated to the Display ad product 109 is used for remarketing 109c distribution. In some implementations, the allocations may be different, there may be different numbers and types of ad products listed, and/or the various options under each ad product may be different in number and/or type. The GUI is not limited to use with the examples described herein.

GUI 100 also includes a cost column 110, which shows the corresponding cost of each allocation. The totals rows 112, 113 show the total amounts allocated for each ad product. In the examples provided herein, the monetary values are in dollars; however any currency may be used.

GUI 100 also includes an area 115 for displaying information relating to each allocation. The information may vary, and may be set by users of the GUI. In this example, the information includes the estimated number of impressions 116 expected for each corresponding allocation, the estimated number of clicks 117 expected for each corresponding allocation, the estimated cost-per-click (CPC) 118 expected for each corresponding allocation, the estimated cost-per-action (CPA) 119 expected for each corresponding allocation, and the estimated number of conversions 120 expected for each corresponding allocation. Area 115 also includes rows 122, 124 showing totals for each ad product.

A check box 125 instructs processes driving the GUI to automatically recommend ad products and budget allocations. As noted above, recommendations may be made based on prior performance of advertising products and allocations for similar advertisers and/or campaigns under similar circumstances. Examples processes for recommending ad products to use in a campaign and corresponding budget allocations are described below.

Sliders 107 may be movable from left to right, and vice versa, in order to increase or to decrease a budget allocation to a particular ad product and/or to a particular option within an ad product. For example, slider 107a may be moved right to increase the allocation of budget to the Search ad product from 80% to, e.g., 90%, 95%, and so forth. Alternatively, slider 107a may be moved left to decrease the allocation of budget to the Search ad product from 80% to 70%, 65%, and so forth. Changing allocations of budget in one ad product can affect allocations in other ad products. For example, decreasing the allocation to the Search ad product by 10% may cause an increase in budget allocation to the Display ad product by 10%. In other implementations, there may not be a direct numerical correlation between increases and decreases in ad products already presented in the GUI. Rather, an increase or decrease in an allocation to an ad product may trigger increases or decreases in allocations to other ad products and/or allocations to different ad products not already presented in the GUI. In any case, the increases or decreases that are triggered are represented by movement of corresponding sliders, making the increases or decreases readily visible to a user.

In some implementations, allocation changes within an ad product may affect only allocations within that ad product. In some implementations, allocation changes within an ad product may affect allocations internal to, and/or external to, that ad product. For example, in FIG. 1, changing a budget allocation for keywords option 109a from 50% to 40% may cause the allocations for placement 109b distribution and/or remarketing 109c to be increased and/or decreased, but not affect allocations to Search ad product 108. In some implementations, changing a budget allocation for keywords option 109a from 50% to 40% may cause the allocations for placement 109b distribution, remarketing 109c, and or Search ad product 108 to be increased and/or decreased, as appropriate.

In response to reallocation, display totals and information provided in area 115 also change in accordance with the reallocation. For example, if the budget allocated to Search ad product 108 decreases, the number of impressions generated, clicks, CPC, CPA and conversions therefor may also change.

In response to manual movement of a slider, such as slider 107a (e.g., in response to budget allocation), other sliders, such as slider 107b, also move to reflect new budget allocations. In some implementations, movement is automatic, e.g., does not require manual intervention, such as refreshing the display. Changes to values in area 115 also occur automatically to reflect new budget allocations. The changes to GUI 100, such as slider movement and value changes, may occur in real-time to enable users to see the effects of reallocations in real-time, and thereby modify their allocations, if desired. In this context, real time includes immediate reaction, which may be limited by the processing and rendering speed of a computing device implementing the systems described herein.

In some implementations, budgets of one or more of the ad products or options within an ad product may be locked. Locked, in some examples, means that the budget is not subject to reallocation, either manually or automatically. In the example of GUI 100, a budget is represented as locked by the appearance of a lock symbol 130 next to the budget. In other implementations, a budget that is locked may be designated as such using different graphics. Accordingly, when reallocation occurs, locked budgets remain as indicated, and the other, unlocked, budgets may vary in accordance with the reallocation. A budget may be locked manually, by a user, by selecting one or more options (not shown) on GUI 100.

The example GUI and associated processes described herein can be implemented in any appropriate network environment, with any appropriate devices and computing equipment. An example of such an environment is described below.

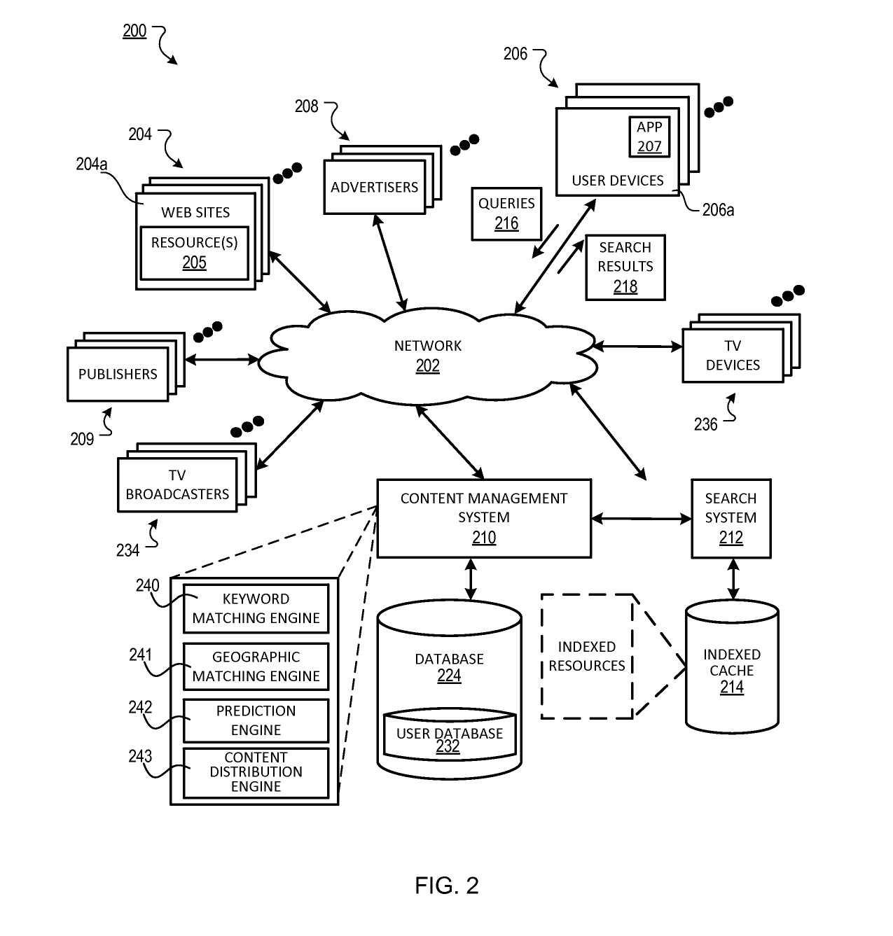

FIG. 2 is a block diagram of an example environment 200 for allocating content distribution budget in accordance with the example processes described herein. The example environment 200 includes a network 202.

Network 202 can represent a communications network that can allow devices, such as a user device 206a, to communicate with entities on the network through a communication interface (not shown), which can include digital signal processing circuitry. Network 202 can include one or more networks. The network(s) can provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication can occur through a radio-frequency transceiver. In addition, short-range communication can occur, such as using a Bluetooth, WiFi, or other such transceiver.

Network 202 connects various entities, such as Web sites 204, user devices 206, content providers (e.g., advertisers 208), online publishers 209, and a content management system 210. In this regard, example environment 200 can include many thousands of Web sites 204, user devices 206, and content providers (e.g., advertisers 208). Entities connected to network 202 include and/or connect through one or more servers. Each such server can be one or more of various forms of servers, such as a Web server, an application server, a proxy server, a network server, or a server farm. Each server can include one or more processing devices, memory, and a storage system.

In FIG. 2, Web sites 204 can include one or more resources 205 associated with a domain name and hosted by one or more servers. An example Web site 204a is a collection of Web pages formatted in hypertext markup language (HTML) that can contain text, images, multimedia content, and programming elements, such as scripts. Each Web site 204 can be maintained by a publisher 209, which is an entity that controls, manages and/or owns the Web site 204.

A resource 205 can be any appropriate data that can be provided over network 202. A resource 205 can be identified by a resource address that is associated with the resource 205. Resources 205 can include HTML pages, word processing documents, portable document format (PDF) documents, images, video, and news feed sources, to name a few. Resources 205 can include content, such as words, phrases, images and sounds, that can include embedded information (such as meta-information hyperlinks) and/or embedded instructions (such as JavaScript scripts).

To facilitate searching of resources 205, environment 200 can include a search system 212 that identifies the resources 205 by crawling and indexing the resources 205 provided by the content publishers on the Web sites 204. Data about the resources 205 can be indexed based on the resource 205 to which the data corresponds. The indexed and, optionally, cached copies of the resources 205 can be stored in an indexed cache 214.

An example user device 206a is an electronic device that is under control of a user and that is capable of requesting and receiving resources over the network 202. A user device can include one or more processing devices, and can be, or include, a mobile telephone (e.g., a smartphone), a laptop computer, a handheld computer, an interactive or so-called “smart” television or set-top box, a tablet computer, a network appliance, a camera, an enhanced general packet radio service (EGPRS) mobile phone, a media player, a navigation device, an email device, a game console, or a combination of any two or more of these data processing devices or other data processing devices. In some implementations, the user device can be included as part of a motor vehicle (e.g., an automobile, an emergency vehicle (e.g., fire truck, ambulance), a bus).

User device 206a typically stores one or more user applications, such as a Web browser, to facilitate the sending and receiving of data over the network 202. A user device 206a that is mobile (or simply, “mobile device”), such as a smartphone or a table computer, can include an application (“app”) 207 that allows the user to conduct a network (e.g., Web) search. User devices 206 can also be equipped with software to communicate with a GPS system, thereby enabling the GPS system to locate the mobile device.

User device 206a can request resources 205 from a Web site 204a. In turn, data representing the resource 205 can be provided to the user device 206a for presentation by the user device 206a. User devices 206 can also submit search queries 216 to the search system 212 over the network 202. A request for a resource 205 or a search query 216 sent from a user device 206 can include an identifier, such as a cookie, identifying the user of the user device.

In response to a search query 216, the search system 212 can access the indexed cache 214 to identify resources 205 that are relevant to the search query 216. The search system 212 identifies the resources 205 in the form of search results 218 and returns the search results 218 to a user device 206 in search results pages. A search result 218 can include data generated by the search system 212 that identifies a resource 205 that is responsive to a particular search query 216, and includes a link to the resource 205. An example search result 218 can include a Web page title, a snippet of text or a portion of an image obtained from the Web page, and the URL (Unified Resource Location) of the Web page.

Content management system 210 can be used for selecting and providing content in response to requests for content. Content management system 210 also can, with appropriate user permission, update database 224 based on activity of a user. The user may enable and/or disable the storing of such information. In this regard, with appropriate user permission, the database 224 can store a profile for the user which includes, for example, information about past user activities, such as visits to a place or event, past requests for resources 205, past search queries 216, other requests for content, Web sites visited, or interactions with content. User interests may also be stored in the profile and, in some examples, may be determined from the information about past user activities. In some implementations, the information in database 224 can be derived, for example, from one or more of a query log, an advertisement log, or requests for content. The database 224 can include, for each entry, a cookie identifying the user, a timestamp, an IP (Internet Protocol) address associated with a requesting user device 206, a type of usage, and details associated with the usage.

Content management system 210 may include a keyword matching engine 240 to compare query keywords to content keywords and to generate a keyword matching score indicative of how well the query keywords match the content keywords. In an example, the keyword matching score is equal, or proportional, to a sum of a number of matches of words in the input query to words associated with the content. Content management system 210 may include a geographic (or “geo-”) matching engine 241 to compare geographic information (e.g., numerical values for place names) obtained from words in input queries to geographic information associated with content. Content management system 210 may also include other engines (not shown) for matching input demographics to desired demographics of an advertising campaign, for identifying Web pages or other distribution mechanisms based on content, and so forth.

When a resource 205 or search results 218 are requested by a user device 206, content management system 210 can receive a request for content to be provided with the resource 205 or search results 218. The request for content can include characteristics of one or more “slots” that are defined for the requested resource 205 or search results page. For example, the data representing the resource 205 can include data specifying a portion of the resource 205 or a portion of a user display, such as a presentation location of a pop-up window or a slot of a third-party content site or Web page, in which content can be presented. An example slot is an ad slot. Search results pages can also include one or more slots in which other content items (e.g., ads) can be presented.

Information about slots can be provided to content management system 210. For example, a reference (e.g., URL) to the resource for which the slot is defined, a size of the slot, and/or media types that are available for presentation in the slot can be provided to the content management system 210. Similarly, keywords associated with a requested resource or a search query 216 for which search results are requested can also be provided to the content management system 210 to facilitate identification of content that is relevant to the resource or search query 216.

Based at least in part on data generated from and/or included in the request, content management system 210 can select content that is eligible to be provided in response to the request (“eligible content items”). For example, eligible content items can include eligible ads having characteristics matching keywords, geographic information, demographic information, known interests, etc. associated with corresponding content. In some implementations, the universe of eligible content items (e.g., ads) can be narrowed by taking into account other factors, such as previous search queries 216. For example, content items corresponding to historical search activities of the user including, e.g., search keywords used, particular content interacted with, sites visited by the user, etc. can also be used in the selection of eligible content items by the content management system 210.

Content management system 210 can select the eligible content items that are to be provided for presentation in slots of a resource 205 or search results page 218 based, at least in part, on results of an auction, such as a second price auction. For example, for eligible content items, content management system 210 can receive bids from content providers (e.g., advertisers 208) and allocate slots, based at least in part on the received bids (e.g., based on the highest bidders at the conclusion of the auction). The bids are amounts that the content providers are willing to pay for presentation (or selection) of their content with a resource 205 or search results page 218. For example, a bid for keywords can specify an amount that a content provider is willing to pay for each 2000 impressions (e.g., presentations) of the content item, referred to as a CPM bid. Alternatively, the bid for keywords can specify an amount that the content provider is willing to pay for a selection (e.g., a click-through) of the content item or a conversion following selection of the content item. This is referred to as cost-per-click (CPC). The selected content item can be determined based on the bids alone, or based on the bids of each bidder being multiplied by one or more factors, such as quality scores derived from content performance, landing page scores, and/or other factors.

In some implementations, a content provider can bid for an audience of users. For example, one or more of the publishers 209 and/or the content management system 210 can identify one or more audiences of users, where each user in the audience matches one or more criteria, such as matching one or more demographics, known interests, or other user-specific criteria.

An audience of users can be represented, for example, as a user list. User lists or other representations of audiences can be stored, for example, in a user database 232. A bid from a content provider can specify, for example, an amount that the content provider is willing to pay for each 2000 impressions (e.g., presentations) of the content item to a particular audience of users. The content management system 210 can, for example, manage the presentation of the content item to users included in a particular audience and can manage charging of the content provider for the impressions and distributing revenue to the publishers 209 based on the impressions.

In some implementations, TV (Television) broadcasters 234 produce and present television content on TV user devices 236, where the television content can be organized into one or more channels. The TV broadcasters 234 can include, along with the television content, one or more content slots in which other content (e.g., advertisements) can be presented. For example, a TV network can sell slots of advertising to advertisers in television programs that they broadcast. Some or all of the content slots can be described in terms of user audiences which represent typical users who watch content with which a respective content slot is associated. Content providers can bid, in an auction (as described above), on a content slot that is associated with keywords for particular television content.

Content management system 210 may include a prediction engine 242. Prediction engine 242 may implement all or part of the example processes described herein for determining budget allocation for content distribution. Content selected for output may be distributed by content distribution engine 243, which is also part of the content management system.

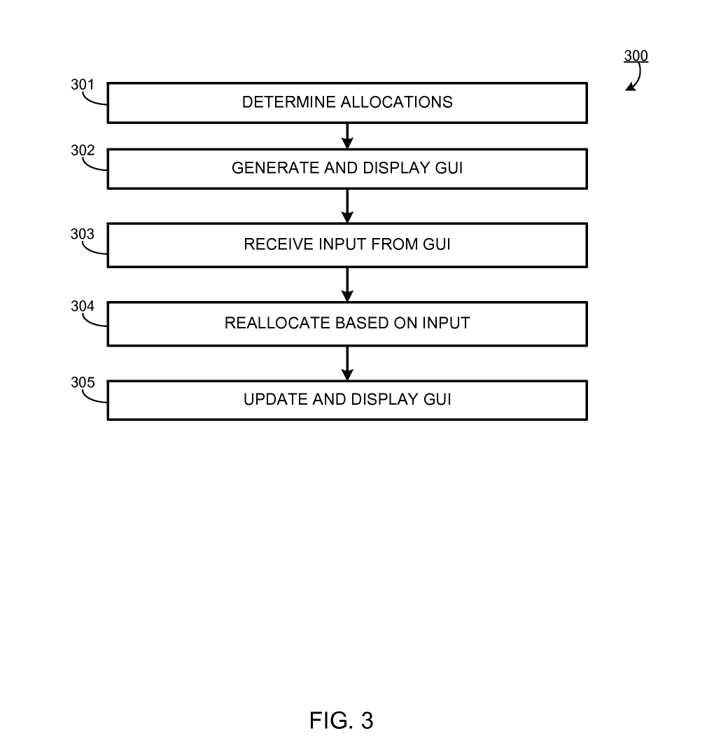

FIG. 3 is a flowchart showing an example process 300 that may be performed by content management system 210 including, at least partly, by prediction engine 242 for determining resource allocation for content distribution. Process 300 is described in the context of online advertising (“ads”); however, process 300 is applicable to determining resource allocation for any appropriate online content or other distributable content.

According to process 300, initial budget allocations are determined (301). In some implementations, the initial budget allocations may be set manually. For example, a user may set the initial budget allocations according to requirements provided by an advertiser. In other implementations, the initial allocations may be determined automatically by processes driving the GUI. For example, budget allocations may be made by comparing a current content (e.g., ad) distribution campaign to past campaigns having one or more features in common with the current campaign, and about which information been stored.

In some implementations, processes for determining budget allocation may take into account all or some of the following information and/or other information not specifically listed: budget size, advertiser identity, marketing objectives of the advertiser, creatives (e.g., ads) available for distribution, audience demographics (e.g., geography, etc.), landing page(s) to which creative(s) direct a user, keywords used in the advertising, historical campaign performance of the advertiser, historical campaign performance of similar campaigns, flight dates of the campaigns, predefined benchmarks associated with a campaign (e.g., conversion goal), appropriate business rules, and so forth. This information may be used in one or more processes to determine appropriate allocations of available budget an advertising campaign.

For example, all or part of foregoing information (and/or other information) may be used to identify past advertising campaigns or portions thereof that involved similar information, to identify the performance of those past advertising campaigns, and to allocate budget in the current advertising campaign based on the performance of the past advertising campaigns. Limitations relating to marketing objectives, benchmarks, business rules, and so forth may also affect budget allocations. Budget may be allocated in order to achieve a target (e.g., maximum) number of conversions or other advertising objective.

A GUI, such as that shown in FIG. 1, may be generated and displayed (302) by process 300. The budget allocations determined above, along with statistics like those found in area 115 of GUI 100, populate the generated GUI. At any time, users may lock any of the budget allocations, as described above.

A user input is received (303) from the GUI. The input may be, e.g., movement of a slider for an ad product or the like. This input may identify the ad product affected, the amount of movement and thus budget to be reallocated, and any other appropriate information. In response to the input, the processes driving the GUI may perform processing to reallocate (304) budget to ad products and/or options within the ad products. The user input (along with any locks) constrains budget allocation in one or more dimensions (e.g., by ad product and percentage of budget allocated to the ad product). Accordingly, during reallocation, the unconstrained budget is allocated in an attempt to best approximate an advertising objective given the applied constraint(s).

Following reallocation (304), the GUI is updated and displayed (305) to the user. The updates include showing updated budget allocations, updated statistics in area 115 relating to the budget allocations, and changes to locations of sliders that correspond to the budget allocations.

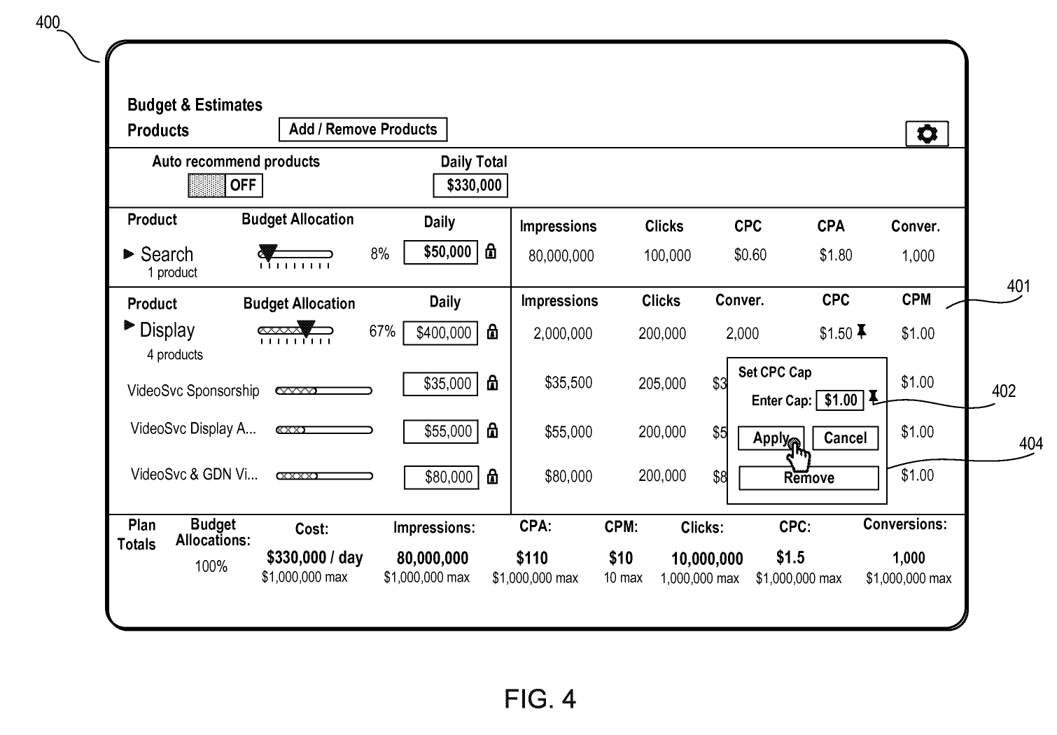

FIG. 4 shows another implementation 400 of a GUI of the type shown in FIG. 1. GUI 400 contains different elements and values than GUI 100. However, the form and function of those elements and values are the same. FIG. 4 also illustrates entry of a constraint into area 401 (which is similar to area 115). For example, as shown in FIG. 4, a user may click on a CPC value for a particular ad product or option. The user may then enter a cap 402 for the ad product into menu 404. That cap may be used to constrain the reallocation of advertising budget, as described above. For example, the advertising budget may be allocated so that the input CPC is not exceeded. Clicking on “Apply” causes the constraint to be entered into the processes driving GUI 400, clicking on “Remove” removes an existing constraint, and clicking on “Cancel” cancels entry. Other constraints, such as this, may be entered for number of impressions, number of clicks, CPA, conversions, and others (not shown). Information about constraints, such as this information input through GUI 400, may be used in budget reallocation (304).

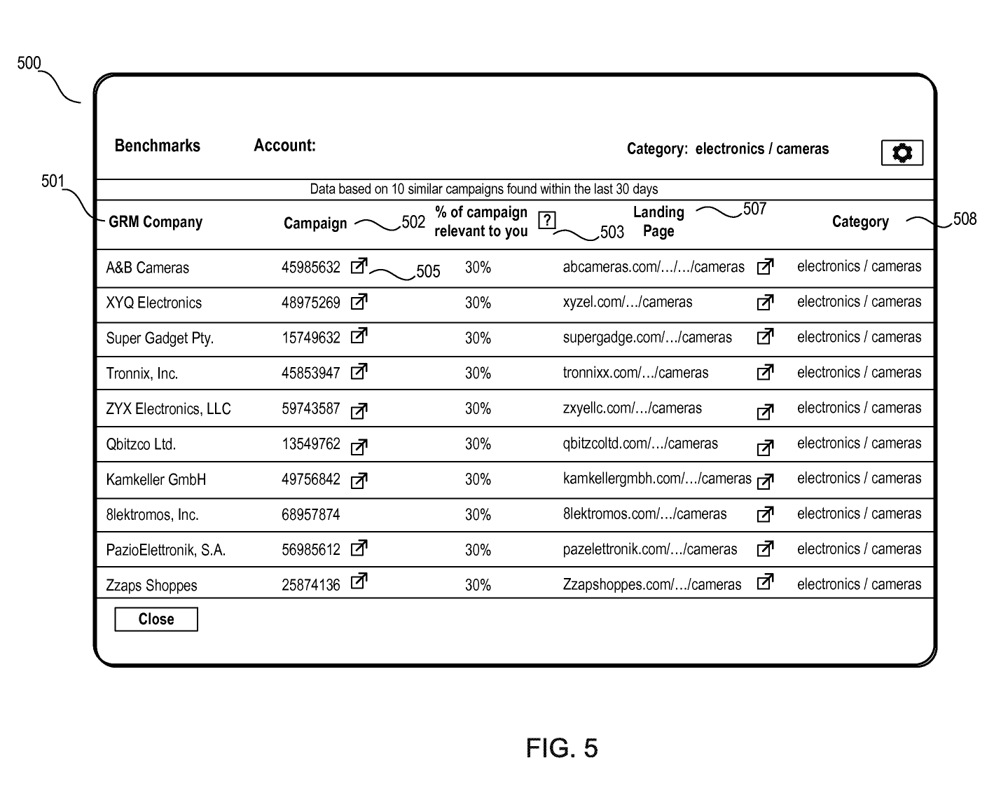

FIG. 5 shows another GUI 500 that may be generated to display justifications for the budget allocations provided in GUIs, such as those provided in GUIs 100 and 400. GUI 500 may be opened (with appropriate permission, if necessary) from an option on GUI 100 or 400. In this example, GUI 500 relates other advertisers and their campaigns that were considered in a current campaign's budget allocation to the current campaign. For example, column 501 identifies the advertisers, column 502 identifies the campaign, and column 503 identifies the percentage of campaign that is relevant to the current campaign. In this regard, relevance may be determined based on similarity between two campaigns. For example, campaign 505 may have 30% similarity to the current campaign (e.g., 30% of features of the two campaigns may be the same or within some acceptable tolerance(s)) and, therefore, its data for the current campaign may be weighted accordingly when making budget allocations about the current campaign.

Similarity may be determined by comparing any appropriate metrics of two campaigns. The metrics may include, but are not limited to, the information described above, namely budget size, advertiser identity, marketing objectives of the advertiser, creatives (e.g., ads) available for distribution, audience demographics (e.g., geography, etc.), landing page(s) to which creative(s) direct a user, keywords used in the advertising, historical campaign performance of the advertiser, historical campaign performance of similar campaigns, flight dates of the campaigns, predefined benchmarks associated with a campaign (e.g., conversion goal), appropriate business rules, and so forth.

GUI 500 also includes a column 507 identifying landing pages associated with each campaign, and a column 508 identifying a category of device or service associated with the corresponding campaign. This information may be part of the information used to determine similarity between two campaigns.

In some implementations, budget allocations and reallocations for GUIs like those shown in FIGS. 1 and 4 may be determined based on, among other things, relative conversion rates of past campaigns. More specifically, as explained above, performance of past content (e.g., advertising) distribution campaigns may be reviewed in order to determine how budget should be allocated. However, different campaign goals can lead to different conversion rates, making a review of raw conversion data less informative as a predictor for future campaigns. For example, the objective of a first advertising campaign may be to have users sign-up to an e-mail distribution list. In such a campaign, the conversion objective (e.g., a sign-up) is relatively easy to achieve, since it takes relatively little effort and does not require a product purchase. Accordingly, the conversion rate may be relatively high (e.g., one conversion per 100 clicks). By contrast, the objective of a second advertising campaign may be to have a user purchase a product. In such a campaign, the advertising objective (e.g., a sale) is more difficult to achieve, since it actually requires the user to purchase a product. Accordingly, the conversion rate may be relatively low (e.g., one conversion per 1000 clicks).

In both above examples of first and second advertising campaigns, the same distribution criteria may be used, e.g., the same keywords, the same geography, the same demographics, and so forth. However, because of the differences in conversion objectives, making a prediction based simply on information used for distribution and conversion rate may not always be informative. Accordingly, the example implementations described herein may use relative conversion rates for various prior content distribution campaigns to make predictions about distribution methods (e.g., ad products) to use in future campaigns. In some implementations, the systems identify distribution clusters that include a type of information used to distribute content and one or more instances of that type of information, determine relative conversion rates for the distribution clusters in different campaigns, compare the relative conversion rates, and use the comparison to make a budget allocation prediction.

By way of example, a system may identify a distribution cluster for advertising relating to cellular telephones. A distribution cluster may be, e.g., a type of information used to distribute content, such as keywords, geography, demographics, language, and so forth. The distribution cluster may include one or more instances or elements of information (e.g., distribution criteria) relating to the distribution cluster. For example, the distribution cluster may be for “keywords”, indicating that keywords are the method of distribution for the data relating to a certain cluster of keywords. For the “cell phone” example, the distribution criteria may be a number of keywords relating to cellular telephones, e.g., “4G LTE”, “texting”, “apps”, “smartphone”, and so forth.

The system may then determine, for different advertising campaigns, what the relative conversion rate is for the above distribution cluster. The relative conversion rate may be determined for a set of (e.g., each) relevant advertising campaigns for which historical performance data is known. Relevant advertising campaigns may include, e.g., advertising campaigns that are for cell phones and that use the distribution cluster for advertising. The relative conversion rate may be determined with respect to an average conversion rate for the distribution cluster for each considered advertising campaign. So, in an example advertising campaign for cell phones, the average conversion rate may be one conversion per 100 clicks. In another example advertising campaign for cell phones, the average conversion rate may be one conversion per 1000 clicks. However, in both example advertising campaigns, it may be determined that the relative conversion rate is two times (“2X”) the expected conversion rate, even though the absolute conversion rates for both campaigns are quite different (e.g., two conversions per 100 clicks versus two conversions per 1000 clicks).

The relative conversion rates of various distribution methods (e.g., keywords, Web-site, demographic, etc. distribution) may be compared to identify which distribution method(s) provides a desired increase(s) in conversion rate. The method(s) that provide the desired increase(s) may be suggested for use, and corresponding budget allocation, in future campaigns.

The distribution clusters may be defined according to any desired granularity, thereby possibly increasing or decreasing the accuracy of the predicted conversion rate for a distribution cluster.

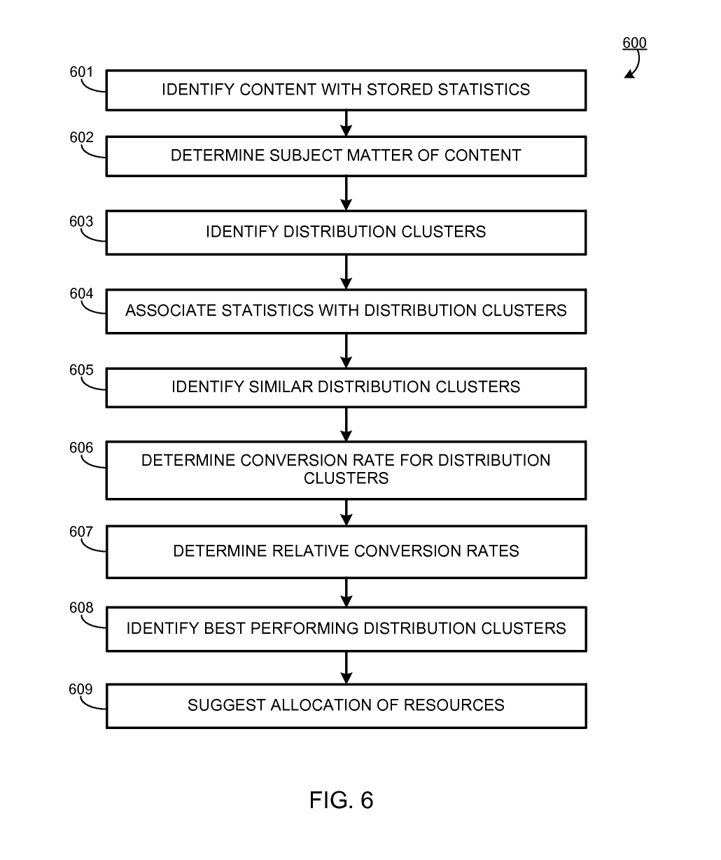

FIG. 6 is a flowchart showing an example process 600 that may be performed by content management system 210 including, at least partly, by prediction engine 242 for determining resource allocation for content distribution. Process 600 is described in the context of online advertising (“ads”); however, process 600 is applicable to determining resource allocation for any appropriate online content or other distributable content.

According to process 600, ads associated with stored statistics are identified (601). The stored statistics may include, but are not limited to, information such as the number of impressions made of each ad, the number of clicks on each ad, the number of conversions resulting from the clicks, the type of activity that constitutes a conversion, information used to distribute each ad, the campaign with which each ad is distributed, publications (e.g., Web sites) on which each ad was distributed during a campaign, and so forth. This information may be collected over time, and stored in a database 224. Users may have the option to prevent storage of personal or confidential information.

The subject of each ad is determined (602). The subject of each ad may be determined using any appropriate method. In some implementations, each ad may be stored with metadata. The metadata may identify the subject of each ad (e.g., cell phone, running shoes, computer, and so forth). In some implementations, the subject of each ad may be determined using image or pattern recognition of content in the ad. In some implementations, the subject of each ad may be identified using information provided by an advertiser and stored with the ad.

In some implementations, the subject matter of each ad may be categorized. For example, different words may be used to categorize the same subject. For example, an ad may be identified as for a “mobile phone” and another ad may be identified as for a “cellular telephone”. Although the two use different words to identify their subject matter, in normal speech, “mobile phone” and “cellular telephone” describe the same type of device. Accordingly, process 600 may identify the same type of device. A hierarchical categorization system may be used to identify different words or phrases that have the same meaning. In the above example, the hierarchical categorization system may have “mobile telephone” at its root and “mobile phone” and “cellular telephone” as branches off of that root. Accordingly, using such a hierarchical categorization system, the system would identify content identified as “cellular telephone” and a “mobile phone” as both being content for a “mobile telephone”.

Distribution clusters are identified (603) for subjects of the content (ads). In some implementations, a distribution cluster includes a type of information used to distribute content and one or more instances of that type of information. For example, the type of information may be keywords and the instances of that type of information may be specific keywords. In the example provided above, examples of keywords for use in an advertising campaign for mobile telephones may be “4G LTE”, “texting”, “apps”, and “smartphone”. Keywords relating to the same subject matter or concepts may be identified using a hierarchical categorization system of the type described above. In another example, the type of information may be demographics. In another example, the type of information may be geography, and the instances of that type of information may be US east coast and US west coast.

Appropriate stored statistics for each distribution cluster are associated (604) with each corresponding distribution cluster. As noted above, such stored statistics may include, but are not limited to, information such as the number of impressions made of each ad, the number of clicks on each ad, the number of conversions resulting from a number of clicks (conversion rate), the type of activity that constitutes a conversion, information used to distribute each ad, the campaign with which each ad is distributed, publications (e.g., Web sites) on which each ad was distributed during the campaign, and so forth. The association may be made using one or more constructs, such as pointers, look-up tables, or the like.

Similar distribution clusters, or “tuples”, are identified (605) in various campaigns. In some implementations, this operation includes identifying distribution clusters having the same information type(s) and the same instances of information (e.g., “keywords” as a type of information and the same keywords as instances of information). In other implementations, similar distribution clusters need not require all instances of information to be the same. For example, in some implementations, similar distribution clusters may include one or more, but not all, instances of information that are the same. In some implementations, distribution clusters may be defined by two types of information (e.g., “keywords” and “demographics”) and instances of each type of information (e.g., “4G LTE” and “smartphone” for “keywords”, and “US east coast” and “US west coast” for “demographics). In such examples, similar distribution clusters may include distribution clusters having at least some common information (e.g., information types and/or instances of information).

The conversion rates for distribution clusters in each campaign are determined (606). For example, statistics about the distribution clusters are known from past campaigns. This information may be used to determine the conversion rate for each distribution cluster in each corresponding campaign.

The relative conversion rates of different distribution clusters in various campaigns are determined (607). This operation may be performed by generating a system of equations relating information about a campaign, the distribution type (e.g., keyword), and the observed conversion rate for the distribution type in the campaign. In some implementations, the system of equations may be as follows:

φᵢθₖ=cvrᵢₖ. (1)

In equations (1), φᵢ is an aggregate conversion rate for a campaign “i”, θₖ is the distribution cluster relative conversion rate multiplier (hence, the subscript designation “k”), and cvrᵢₖ is the observed distribution cluster conversion rate “k” for campaign “i”. A distribution cluster having a neutral or average conversion rate would typically have a value of one for θₖ. In equations (1), only cvrᵢₖ is known from stored statistics relating for each campaign.

Equations (1) are solved for θₖ, which is the relative conversion rate for each distribution cluster k. For example, the relative conversion rate may indicate that a distribution cluster using keywords as a distribution method has a relative conversion rate of twice that of an average conversion rate in a campaign. In some implementations, equations (1) are solved using iterative proportional fitting. This solution mechanism includes initially setting all values of θₖ to one, estimating values for φᵢ that provide approximate solutions to the equations, and then alternating estimates of θₖ and φᵢ until a solution to equations (1) that has a desired level of stability is determined.

The values of θₖ, which are the relative conversion rates of different distribution clusters, are compared to identify (608) one or more distribution clusters that provide the best relative performance (e.g., the highest relative conversion rate(s)). This information is used to suggest (609) allocation of resources. For example, the information may be used to suggest that budget for advertising or other types of content distribution be skewed in favor of distribution clusters that provide the highest relative conversion rates. For example, if it is determined that keyword-based distribution produces the highest relative conversion rates, then it may be suggested that a majority of the advertising budget be allocated to keyword-based distribution. In some implementations, the allocation of advertising budget may be correlated to the relative conversion rates. For example, if the relative conversion rates of keyword distribution are two times higher than a baseline, and the relative conversion rates of Web site based distribution are about at the baseline, then it may be suggested that two times more advertising budget be allocated to keyword distribution than to Web site based distribution. This information may be reflected in budget allocation GUI, such as GUIs 100 and 400.

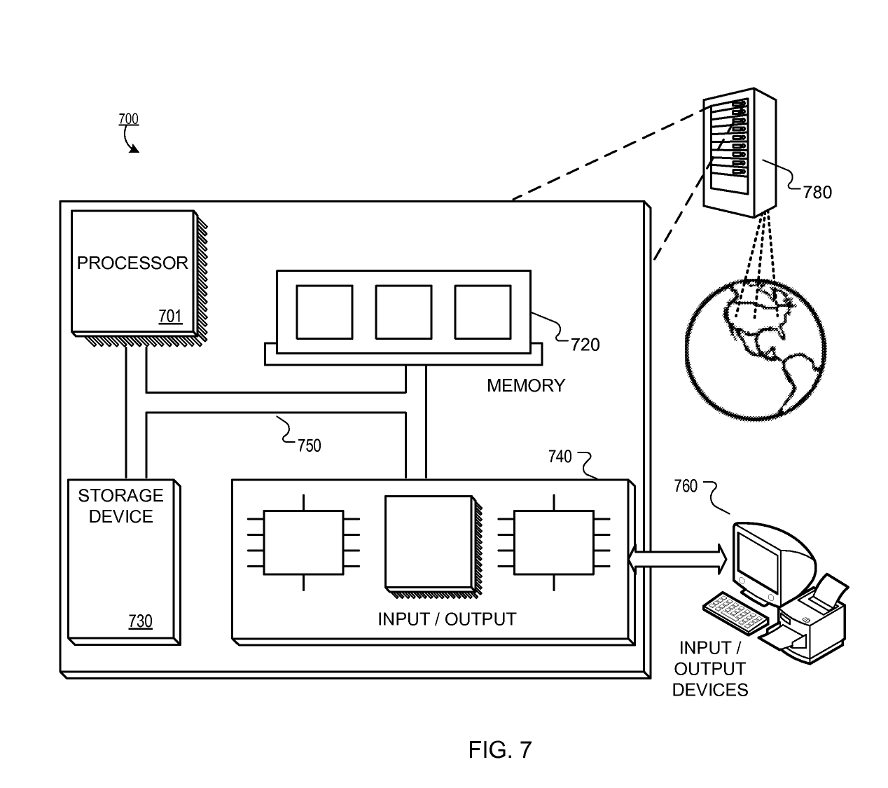

FIG. 7 is block diagram of an example computer system 700 that may be used in performing the processes described herein. The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can include, for example, a hard disk device, an optical disk device, or some other large capacity storage device.

The input/output device 740 provides input/output operations for the system 700. In one implementation, the input/output device 740 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 760.

The web server, advertisement server, and impression allocation module can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The web server and advertisement server can be distributively implemented over a network, such as a server farm, or can be implemented in a single computer device.

Example computer system 700 is depicted as a rack in a server 780 in this example. As shown the server may include multiple such racks. Various servers, which may act in concert to perform the processes described herein, may be at different geographic locations, as shown in the figure. The processes described herein may be implemented on such a server or on multiple such servers. As shown, the servers may be provided at a single location or located at various places throughout the globe. The servers may coordinate their operation in order to provide the capabilities to implement the processes.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

In this regard, various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Content, such as ads and GUIs, generated according to the processes described herein may be displayed on a computer peripheral (e.g., a monitor) associated with a computer. The display physically transforms the computer peripheral. For example, if the computer peripheral is an LCD display, the orientations of liquid crystals are changed by the application of biasing voltages in a physical transformation that is visually apparent to the user. As another example, if the computer peripheral is a cathode ray tube (CRT), the state of a fluorescent screen is changed by the impact of electrons in a physical transformation that is also visually apparent. Moreover, the display of content on a computer peripheral is tied to a particular machine, namely, the computer peripheral.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Elements of different implementations described herein can be combined to form other implementations not specifically set forth above. Elements can be left out of the processes, computer programs, Web pages, etc. described herein without adversely affecting their operation. In addition, the logic flows depicted in the figures do not require the particular order shown, or sequential order, to achieve desirable results. Various separate elements can be combined into one or more individual elements to perform the functions described herein.

Other implementations not specifically described herein are also within the scope of the following claims.

What is claimed is:

1. A method performed by one or more processing devices, comprising:
determining, using the one or more processing devices, how to allocate a budget among different content distribution mechanisms, wherein a content distribution mechanism comprises a method of distributing content over one or more communications media;
generating a graphical user interface showing allocations of the budget among the different content distribution mechanisms, the graphical user interface comprising elements to vary the allocations, the elements being movable to trigger variations in the allocations;
receiving an input from the graphical user interface, the input indicating that at least one of the elements has been moved;
determining, using the one or more processing devices, a reallocation of the budget among the different content distribution mechanisms based on the input received from the graphical user interface; and
updating the graphical user interface using the reallocation of the budget among the different content distribution mechanisms, the graphical user interface being updated so that at least some of the elements and information relating to the content distribution mechanisms reflect the reallocation of the budget.

2. The method of claim 1, further comprising:
locking one or more budget allocations to corresponding content distribution mechanisms;
wherein the reallocation is determined without affecting the one or more budget allocations to the corresponding content distribution mechanisms.

3. The method of claim 1, wherein the elements comprise sliders and wherein the information relating to the content distribution mechanisms comprises content distribution statistics for a content distribution mechanism that correspond to a budget allocation for the content distribution mechanism; and
wherein updating the graphical user interface comprises changing display of at least some of the elements and at least some of the content distribution statistics.

4. The method of claim 3, wherein changes to display of at least some of the elements and at least some of the content distribution statistics are performed in real-time.

5. The method of claim 1, wherein at least one of the content distribution mechanisms comprises:
one or more options for distributing content that falls within a category of the at least one content distribution mechanism.

6. The method of claim 5, further comprising:
locking an allocation for at least one of the options;
wherein the allocation for at least one of the options is unaffected by the reallocation; and
wherein reallocation affects at least one other option within the at least one content distribution mechanism but allocations for other content distribution mechanisms are unaffected by the reallocation.

7. The method of claim 5, further comprising:
locking an allocation for at least one of the options;
wherein the allocation for at least one of the options is unaffected by the reallocation; and
wherein reallocation affects a content distribution mechanism other than the at least one content distribution mechanism.

8. The method of claim 1, wherein determining how to allocate the budget comprises:
for multiple content distribution campaigns:
identifying distribution clusters associated with a campaign for content distribution, a distribution cluster comprising a type of information used to distribute content and one or more instances of the type of information; and
determining relative conversion rates for the distribution clusters, a relative conversion rate indicating a performance of a distribution cluster relative to a baseline performance for the campaign, at least some of the distribution clusters using different types of information to distribute content; and
using relative conversion rates for similar distribution clusters in different campaigns in determining how to allocate the budget among the different content distribution mechanisms.

9. The method of claim 1, wherein determining reallocation of the budget comprises:
for multiple content distribution campaigns:
identifying distribution clusters associated with a campaign for content distribution, a distribution cluster comprising a type of information used to distribute content and one or more instances of the type of information; and
determining relative conversion rates for the distribution clusters, a relative conversion rate indicating a performance of distribution cluster relative to a baseline performance for the campaign, at least some of the distribution clusters using different types of information to distribute content; and
using relative conversion rates for similar distribution clusters in different campaigns in determining how to reallocate the budget among the different content distribution mechanisms.

10. The method of claim 1, further comprising:
entering a cap into the graphical user interface for restraining reallocation of advertising budget.

11. One or more machine-readable storage devices storing instructions that are executable by one or more processing devices to perform operations comprising:
determining how to allocate a budget among different content distribution mechanisms, wherein a content distribution mechanism comprises a one or more machine-readable storage devices of distributing content over one or more communications media;
generating a graphical user interface showing allocations of the budget among the different content distribution mechanisms, the graphical user interface comprising elements to vary the allocations, the elements being movable to trigger variations in the allocations;
receiving an input from the graphical user interface, the input indicating that at least one of the elements has been moved;
determining a reallocation of the budget among the different content distribution mechanisms based on the input received from the graphical user interface; and
updating the graphical user interface using the reallocation of the budget among the different content distribution mechanisms, the graphical user interface being updated so that at least some of the elements and information relating to the content distribution mechanisms reflect the reallocation of the budget.

12. The one or more machine-readable storage devices of claim 11, wherein the operations comprise locking one or more budget allocations to corresponding content distribution mechanisms; and
wherein the reallocation is determined without affecting the one or more budget allocations to the corresponding content distribution mechanisms.

13. The one or more machine-readable storage devices of claim 11, wherein the elements comprise sliders and wherein the information relating to the content distribution mechanisms comprises content distribution statistics for a content distribution mechanism that correspond to a budget allocation for the content distribution mechanism; and
wherein updating the graphical user interface comprises changing display of at least some of the elements and at least some of the content distribution statistics.

14. The one or more machine-readable storage devices of claim 13, wherein changes to display of at least some of the elements and at least some of the content distribution statistics are performed in real-time.

15. The one or more machine-readable storage devices of claim 11, wherein at least one of the content distribution mechanisms comprises:
one or more options for distributing content that falls within a category of the at least one content distribution mechanism.

16. The one or more machine-readable storage devices of claim 15, wherein the operations comprise locking an allocation for at least one of the options;
wherein the allocation for at least one of the options is unaffected by the reallocation; and
wherein reallocation affects at least one other option within the at least one content distribution mechanism but allocations for other content distribution mechanisms are unaffected by the reallocation.

17. The one or more machine-readable storage devices of claim 15, wherein the operations comprise locking an allocation for at least one of the options;
wherein the allocation for at least one of the options is unaffected by the reallocation; and
wherein reallocation affects a content distribution mechanism other than the at least one content distribution mechanism.

18. The one or more machine-readable storage devices of claim 11, wherein determining how to allocate or to reallocate the budget comprises:
for multiple content distribution campaigns:
identifying distribution clusters associated with a campaign for content distribution, a distribution cluster comprising a type of information used to distribute content and one or more instances of the type of information; and
determining relative conversion rates for the distribution clusters, a relative conversion rate indicating a performance of a distribution cluster relative to a baseline performance for the campaign, at least some of the distribution clusters using different types of information to distribute content; and
using relative conversion rates for similar distribution clusters in different campaigns in determining how to allocate or to reallocate the budget among the different content distribution mechanisms.

19. The one or more machine-readable storage devices of claim 11, wherein the operations comprise:
entering a cap into the graphical user interface for restraining reallocation of advertising budget.

20. A system comprising:
memory storing instructions that are executable; and
one or more processing devices to execute the instructions to perform operations comprising:
determining how to allocate a budget among different content distribution mechanisms, wherein a content distribution mechanism comprises a method of distributing content over one or more communications media;
generating a graphical user interface showing allocations of the budget among the different content distribution mechanisms, the graphical user interface comprising elements to vary the allocations, the elements being movable to trigger variations in the allocations;
receiving an input from the graphical user interface, the input indicating that at least one of the elements has been moved;
determining a reallocation of the budget among the different content distribution mechanisms based on the input received from the graphical user interface; and
updating the graphical user interface using the reallocation of the budget among the different content distribution mechanisms, the graphical user interface being updated so that at least some of the elements and information relating to the content distribution mechanisms reflect the reallocation of the budget.
